(19) United States
(12) Patent Application Publication
(10) Pub. No.: US 2021/0064199 A1
(43) Pub. Date: Mar. 4, 2021

(54) FORENSICS LAB GRAPHICAL USER INTERFACE DASHBOARD

(71) Applicant: Houston Forensic Science Center, Inc., Houston, TX (US)

(72) Inventors: Amy Castillo, Houston, TX (US); William Arnold, Katy, TX (US); Kathleen Sill, Irmo, SC (US); James Miller, Houston, TX (US); Donna Eudaley, Houston, TX (US); Paula Evans, Pearland, TX (US); Aimee Grimaldi, Pearland, TX (US)

(21) Appl. No.: 16/552,581

(22) Filed: Aug. 27, 2019

(51) Int. Cl. G06F 3/0484; G06F 9/451; G06F 16/245; G06F 3/0482

(52) U.S. Cl. CPC G06F 3/0484; G06F 3/0482; G06F 16/245; G06F 9/451

(57) ABSTRACT

Examples herein describe systems and methods for providing a graphical user interface (“GUI”) dashboard. Data can be retrieved from multiple sources. The data can be processed, and the processed data can be used to generate a GUI in dashboard format. The dashboard can have multiple GUI elements that allow user interaction. The GUI elements, or portions thereof, can be selected, resulting in the remaining GUI elements changing how data is presented or changing the dashboard to a detailed view. The GUI dashboard can be updated in real time.

### BACKGROUND

Graphical user interfaces (“GUIs”) are a form of visual interface that allows a user to interact with a computer. Many industries use a type of GUI called a dashboard that makes it easier for users to interact with the backend of an application and access certain types of information. Dashboards can also present information in an easy-to-read format that may otherwise be inaccessible within a usable time window, which can allow entities to act on the information provided.

Dashboards available today are unable to provide many businesses, such as forensics labs, with practical access to the data critical to knowing if the business is meeting the customer's needs in a way that is actionable. The data necessary to accomplish this can be untimely, unreliable, difficult to retrieve, undefined, used inconsistently, and, when available, not presented in a way that provides intelligence that can be used to make operational and business decisions. Furthermore, businesses often require analysis of data from multiple sources, such as quality management and laboratory information management systems. Current data systems in many fields lack the ability to combine data from multiple sources in an actionable way. This results in inefficient business practices that hinder the ability of forensic labs to adapt and achieve their goals, or to communicate the resources they need.

As a result, a need exists for a GUI dashboard that can reliably provide actionable data from multiple data sources in real time.

### SUMMARY

Examples described herein include systems and methods for providing a forensics lab graphical user interface dashboard. The systems and methods presented herein relate to retrieving database views from multiple data sources and presenting the data in an actionable format.

In one example, a computing device may retrieve and process data from multiple data sources. Using the processed data, the computing device may generate instructions for running and displaying a GUI on a client device. The GUI may present the processed data in a dashboard format. A dashboard format can be any GUI format that presents information in a way that is easy to read and allows a user interaction. The dashboard can be updated in real time using, for example, an open-ended SQL query.

The dashboard can have multiple GUI elements. An example GUI element can be an interactive component of a GUI that allows a user to interact, such as a widget. The elements may display data in various forms to provide specifically needed information. Any number of the elements, such as the example elements discussed below, can be shown on the dashboard at the same time. One example element may list users to whom requests have been assigned. A request can be a solicitation for services received by an organization. The element can include a graph next to each user that represents the number of open requests assigned to that user. As an example, each graph can be a stacked bar graph that shows assigned requests broken down by phase of work. Examples of phases of work categories can be “Unassigned,” “Pending Draft,” “Pending Tech Review,” and “Pending Admin.”

Some example elements may display information relating to open requests. Some such example elements may display counts of open requests in certain predetermined categories, counts of open requests broken down by phase of work, the average age of pending critical requests, the number of quality incidents reports that have been open for a predetermined amount of time, the average age of open quality incident reports, and a list of quality incident reports currently open.

Other example elements may display statistical related data for completed requests. Some such example elements may display the number of requests completed by each user during a time period, the turnaround time (“TAT”) of all requests completed during a time period broken down by phase of work, the TAT of quality incident reports during a time period, and the number of requests received and the number of requests completed during a time period.

The elements can be interactive. For example, the elements can be selectable by a user interacting with the GUI. A selection can cause a change in other elements within the dashboard. Some example selection types can be a tap, click, double-click, and hover. As an example, a selection of a user from the previously discussed user list can cause other elements to highlight or only display data corresponding to the selected user. In another example, a different selection relating to the same user can cause the GUI to display detailed data relating to the user in a non-dashboard format. Additionally, a hover selection can, as an example, cause a window to be displayed showing additional information relating to the user.

The dashboard can include selectable filters that filter the data or elements shown in the dashboard. One example filter can filter the data or elements shown according to a user role. For example, an analyst role can cause the dashboard to filter the data and elements displayed to show only what is necessary for an analyst, whereas a supervisor role can show additional data and elements inaccessible to an analyst. Another example filter can filter the data or elements shown according to a user. For example, a supervisor can select him or herself in the filter, and the dashboard may then show the data and elements relating to the analysts he or she oversees. Other example filters can filter by service type or forensic discipline, which are explained in more detail herein.

In an example, the dashboard may include a detailed data element that, when selected, can provide a more detailed view of certain data. For example, the detailed view can include line items of requests with a request case ID, any associated names, request age, request status, or a reason for the request being in a certain status. In an example, the detailed view may present detailed information from the database views generally. In another example, the GUI elements on the dashboard can have a corresponding detailed element that, when selected, causes a detailed view of data relating to that element to be presented in the GUI.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for providing a GUI that includes multiple GUI elements relating to multiple data sources.

FIG. 2 is another flowchart of an example method providing a GUI that includes multiple GUI elements relating to multiple data sources.

FIGS. 3A-3D illustrate an example GUI that includes multiple GUI elements relating to multiple data sources.

FIGS. 4A-4D illustrate an example GUI from FIGS. 3A-3D with a selected element.

FIG. 5 is an illustration of a system for providing a GUI as described herein.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Examples herein describe systems and methods for providing a GUI in dashboard format. A computing device may retrieve data from multiple data sources. The computing device can process the data, and then use the processed data to generate instructions for running and displaying a GUI in dashboard format. The computing device may transfer the instructions to a client computing device. The computing device may update the instructions in real time as updated information becomes available.

The dashboard can have multiple GUI elements that present information in various formats. The GUI elements, or portions thereof, can be selected, resulting in the remaining GUI elements changing how the information is presented. Some GUI elements can cause more detailed information to be provided. Some GUI elements can provide an option to filter the information presented in the dashboard.

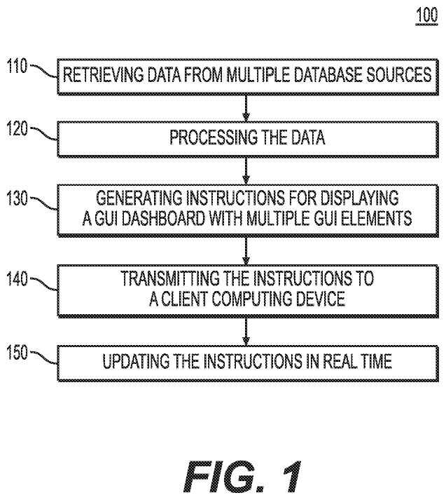

FIG. 1 is flowchart of an example method for providing a GUI in dashboard format. Although references are made herein to forensics data and other forensics-related things, those references are merely used as examples and are not intended to be limiting in any way. For example, a reference to “forensics-lab data” can encompass any type of data, even if not related to forensics in any way.

At stage 110, a computing device may retrieve data from multiple data sources based on certain parameters. An example computing device can be a hardware-processor-based device having a memory storage, such as a server, phone, tablet, or personal computer. A data source can be any source of information outside of the computing device receiving the information at stage 110. For example, a data source can be a database server accessible to the computing device. The computing device can make an application programming interface (“API”) call to a server to request information, for example, and the server can respond with one or more data files in response to the request. The data files can be XML or JSON files, for example.

In another example the computing device can retrieve data using a relational data stream management system (RDSMS). An RDSMS is a type of data management system where a computing device can continuously query a data source using SQL standards. SQL queries return information in the form of a view, which is a virtual table that represents a subset of data contained in the data source based on parameters defined in the query. In more traditional database systems SQL queries return a result and then end, so a new query must be made to receive any new information. In an RDSMS, the SQL query is open ended, so the data source continuously transfers new data to the computing device as it becomes available. Additionally, in an RDSMS, the computing device stores the query defining the view rather than all the data in the data source's tables, which results in the computing device using minimal computing resources. An RDSMS can be advantageous because new information can be received in real time using minimal computing resources. It is contemplated that there may other methods known in the art for retrieving data from multiple databases that can be used in conjunction with the present invention.

Example data sources can include a laboratory information management system (“LIMS”) and compliance management systems. A LIMS is a software-based system that supports modern laboratory operations. It allows labs to manage the flow and associated data of lab samples. The core functions of LIMS include sample management, instrument integration, and data storage and exchange. Compliance management systems are software-based systems that assist organizations with ensuring their processes comply with applicable laws, policies, and other applicable standards.

At stage 120, the computing device may process the data. Data processing can include processes such as validation, sorting, summarization, aggregation, analysis, reporting, and classification. In an example, the computing device may query multiple databases using parameters that cause the data to be received in processed form. Importing all the data from the data sources and then processing the data on the computing device can be time consuming and put a strain on the computing device. Using database queries, such as SQL queries, the computing device can cause the data to be received having already been processed. The computing device would need to store only the query commands and database views.

At times the necessary data processing may be too complex to achieve solely through database queries. In such instances, the computing device can, for example, use database queries to process all data that database queries can adequately process. For all other data processing, the computing device can query the data source for the necessary subsets of data needed and then process the data within the computing device using a built-in software engine.

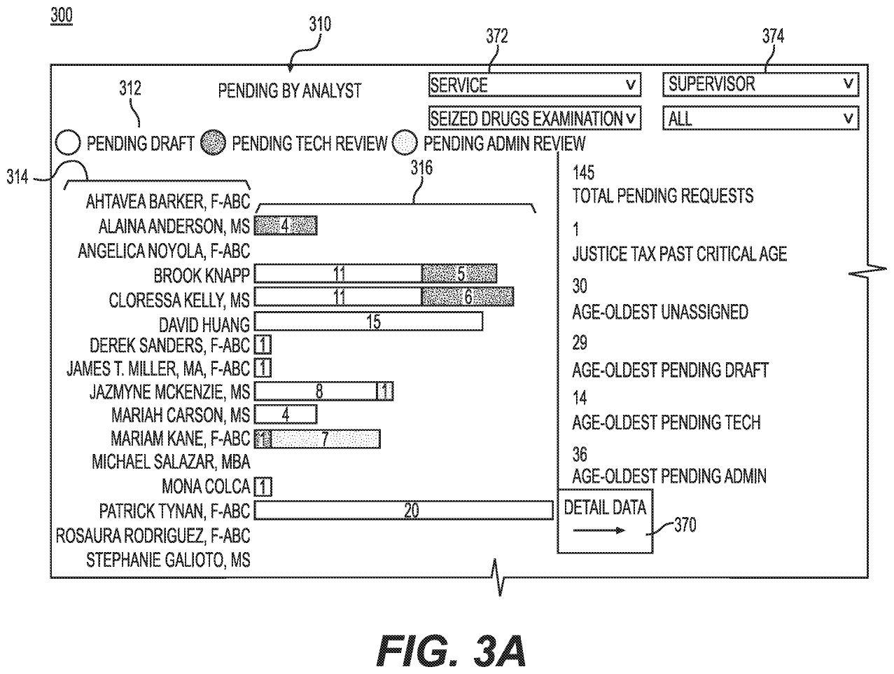

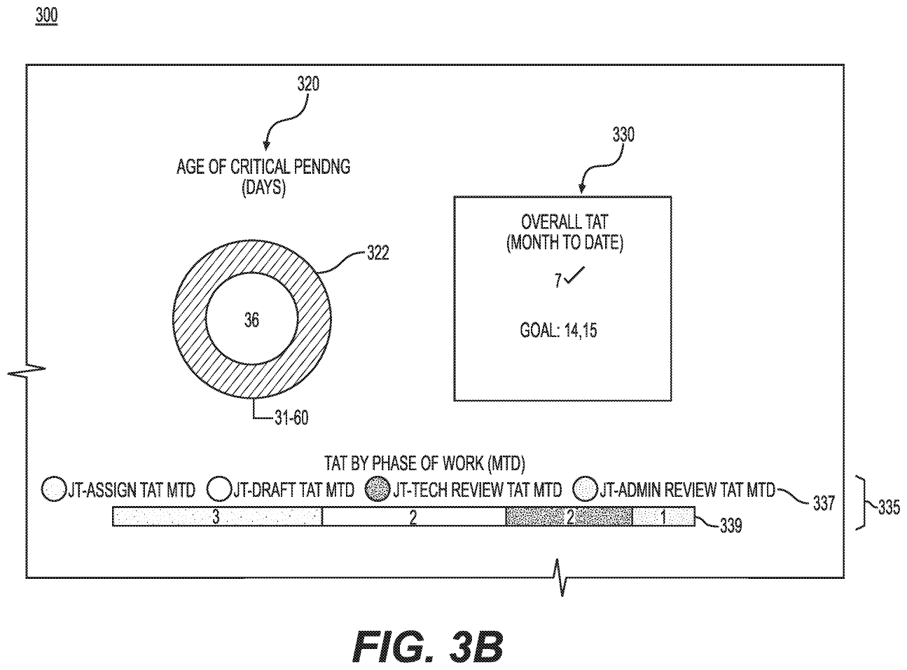

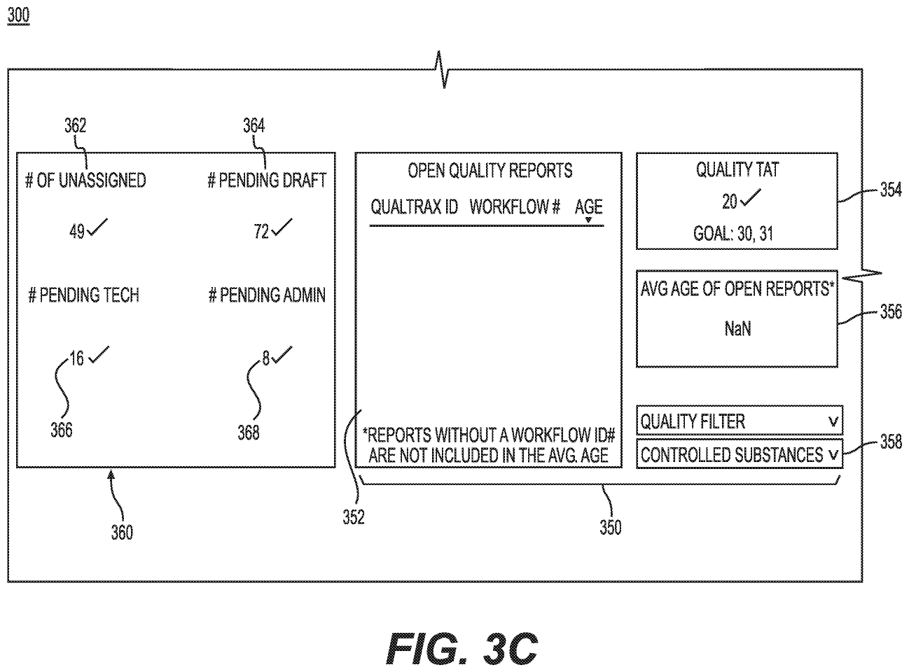

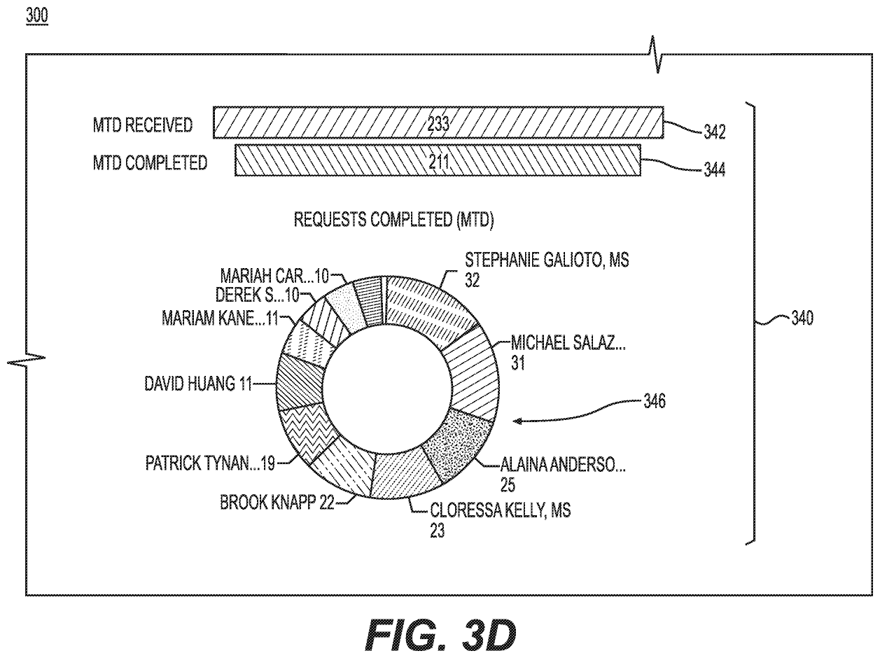

At stage 130, the computing device may generate instructions for displaying a GUI in dashboard format. A dashboard can be any GUI format that presents information in a way that is easy to read and allows a user to interact with GUI elements of the dashboard. It can visually present otherwise complicated data in a way that is easy to understand. The GUI can include multiple GUI elements. Each element in the dashboard can provide actionable data based on predetermined criteria established by an organization using the dashboard. The GUI elements are discussed in further detail herein starting with FIG. 3A.

At stage 140, the computing device may transmit the GUI dashboard instructions to a client device. A client device can be one or more processor-based devices, such as a personal computer, laptop, tablet, or cell phone, that includes a display in which a user can interact with an interface. The client device can execute the instructions to display the GUI on its display.

At stage 150, the computing device may update the GUI dashboard instructions in real time. For example, the computing device may receive updated data from the data sources, update the instructions for running and displaying the GUI dashboard, and then transmit the updated instructions to the client device so that they client device may update the GUI dashboard on its display. Some methods allow for data to be retrieved in real time without putting a strain on the system from importing and processing large quantities of data. As explained above, an RDSMS is an example system that imports virtual data tables using open-ended SQL queries that cause data sources to continuously transfer new data as it arrives. Using such a system allows the computing device to update the GUI dashboard instructions with minimal delay.

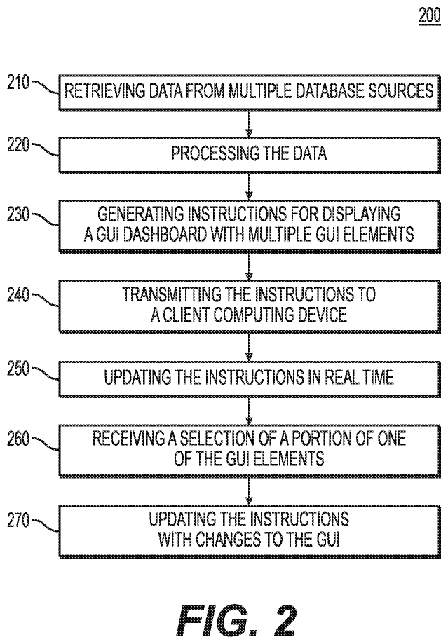

FIG. 2 is an alternate example method for providing a forensics dashboard. Stages 210, 220, 230, 240, and 250 represent method steps as described with respect to stages 110, 120, 130, 140, and 150, respectively, from FIG. 1. The method of FIG. 2 includes the additional steps of stages 260 and 270.

At stage 260, the computing device may receive of a selection of at least a portion of one of the multiple GUI elements. A GUI element can be an interactive component of a GUI that allows a user to interact with the element, such as a widget. In an example, the computing device can detect various types of selections, such as a tap, a click, a double-click, or a hover.

At stage 270, responsive to receiving the selection, the computing device may update the GUI dashboard instructions, causing the GUI displayed on the client devices to change. The type of change caused in the GUI may depend on the type and location of the selection received. For example, upon receiving a selection, such as a tap or click, of a portion of an element, the computing device may cause the information displayed in other elements to change. Upon receiving a selection of a different portion of the element, the computing device may cause the GUI to display information in an entirely different format. Upon receiving a different type of selection, such as a hover, of a portion of an element, the computing device may cause a pop-up window to be displayed with additional information.

In an example, one element in the GUI contains a list of names of analysts in an organization. Other elements in the GUI contain other information relating to the analysts listed. A user interacts with the GUI by selecting one of the analyst names with a click, such as a mouse click. Upon receiving the selection, the computing device provides updated instructions that cause the other elements of the GUI containing information relating to the analysts to change. For example, the colors and shading of the relating elements can change to highlight information relating to the selected analyst name. In another example, the relating elements may only display information relating to the selected analyst.

Continuing the previous example, a user interacts with the GUI by selecting, in a similar manner, a different portion of the element containing the list of analyst names. For example, each name can have a proximately located button sub-element. The user selects the button for an analyst. Upon receiving the selection, the computing device may cause the GUI to no longer display the information in a dashboard format. Instead, the computing device causes the GUI to display detailed information relating to the selected analyst. To obtain the detailed information, the computing device can execute a new set of queries to the multiple databases or retrieve information already stored at the computing device.

Continuing the previous example, a user interacts with the GUI by hovering a pointing device, such as a mouse pointer, over an analyst name from the list. Upon detecting the hover, such as by detecting that the mouse pointer location corresponds to the GUI location for a predetermined period of time, the computing device causes a pop-up window to be displayed with additional information relating to the analyst.

In an alternative example, the selection can be from a drop-down menu with options to filter the data in the dashboard. For example, a drop-down menu selection could filter the data according to a user role, such as analyst, manager, or administrator. Another example of a filter could be service type. Generally speaking, a service type can be a category of the type of service to be performed for a request. For example, some service types in a forensics lab are audio video call out, audio video examination, blood alcohol, Combined DNA Index System (CODIS), crime scene unit response, digital forensics examination, DNA analysis, firearms examination, latent prints comparison, latent print physical evidence processing, firearms evidence processing, outsourced forensic biology analysis, firearms reprint report, biological fluid screening, seized drug examination, toxicology analysis, and Y-chromosome short tandem repeats testing. Another example of a filter for a forensics lab could be forensic discipline, such as crime scene unit, digital multimedia, firearms/NIBIN, forensic biology, latent prints, seized drugs, and toxicology. The data can be filtered in any way, based on any attribute relating to the relevant data.

FIGS. 3A-3D show an example dashboard 300 in a GUI. Each of FIGS. 3A-3D show a portion of example dashboard 300 and have been separated for illustration purposes. The GUI element described herein with respect to FIGS. 3A-3D can be combined in different ways and locations in dashboard 300 depending on the needs of the user. Dashboard 300 can include multiple GUI elements, such as Pending by Analyst element 310 and Detailed Data element 370 shown in FIG. 3A; Age of Critical Pending element 320, Overall TAT element 330, and TAT by Phase of Work element 335 shown in FIG. 3B; Quality Reports element 350 and Pending Request Status element 360 shown in FIG. 3C; and Requests Received/Completed element 340 shown in FIG. 3D. A GUI element can be a component of a GUI that allows for user interaction.

Pending by Analyst element 310 can include, for example, a list of analysts 314. Proximately located to each analyst in the list of analysts 314 can be a visualization of pending requests 316 assigned to the respective analyst. The visualization of pending requests 316 can be, for example, a stacked bar graph that depicts the number of pending requests segmented by different phases of work as shown in FIG. 3A. Pending by Analyst element 310 can also include a pending status legend 312 corresponding to each phase of work depicted in the visualization of pending requests 316.

Examples of phases of work can be “Unassigned,” “Pending Draft,” “Pending Tech Review,” and “Pending Admin.” The status of a request can refer to which phase of work the request is in. Unassigned can mean requests that have not yet been assigned to an analyst. Pending Draft can mean requests that have been assigned to an analyst but have not yet had a draft report created in a laboratory information management system (“LIMS”). Pending Tech Review can mean requests awaiting technical review by qualified personnel. A technical review can include, but is not limited to, ensuring that the technical aspects of work performed conform with standard operating procedures or a quality manual. Pending Admin can mean requests awaiting administrative review by qualified personnel. An administrative review can include, but is not limited to, proper report formatting, spelling, and other documentation requirements as outlined in standard operating procedures or a quality manual.

Age of Critical Pending element 320 can display the average age of pending requests that have been open beyond a predetermined threshold. For example, Age of Critical Pending element 320 can depict the average age of pending requests that have been open for more than 30 days. Age of Critical Pending element 320 can include a graphic 322. As an example, graphic 322 can be a ring chart that depicts the average age of pending requests over 30 days. The ring chart can have sections for different predetermined day ranges where the number of requests that fit in each range can be represented as a different color. For example, the number of pending requests that have been pending for 31-60 days can be in green in the ring chart, 61-90 days in yellow, and above 90 in red.

Overall TAT element 330 can display the average turnaround time for all requests. Overall TAT element 330 can display the average turnaround time as a number. The number can be color-coded according to certain parameters. For example, if the average turnaround time is below a goal, or threshold, then the number can be displayed in green. If the average turnaround time exceeds the threshold, then it can be display in red. Overall TAT element 330 can display the average turnaround time number over a specified time, such as, for example, month-to-date or the past 90 days.

TAT by Phase of Work element 335 can display the average number of days to complete each phase of work for completed requests over a specified period. The phases of work can be, for example, “Assign,” “Draft,” “Tech Review,” and “Admin Review.” TAT by Phase of Work element 335 can include a stacked bar graph 339 that depicts the number of completed requests separated by phase of work as shown in FIG. 3B. TAT by Phase of Work element 335 can also include a pending status legend 337 corresponding to the phases of work depicted in stacked bar graph 339.

Requests Received/Completed element 340 can display the number of requests received and completed over a specified period. Such a specified period can be, for example, month-to-date. Requests Received/Completed element 340 can include visualizations of the number of requests received 342 and the number of requests completed 344. Visualizations 342 and 344 can be displayed as “bars” as shown in FIG. 3D where the length is dependent on the number of requests received (342) or completed (344). Requests Received/Completed element 340 can also include a ring chart 346 that displays the number of requests completed by each user in list 314 over a specified period.

Quality Reports element 350 can display information related to quality management incidents open. Quality Reports element 350 can include Open Quality Reports element 352, Quality TAT element 354, Average age of Open Reports element 356, and Quality Filter element 358. Open Quality Reports element 352 can display a list of quality incidents currently open. Open quality incidents can be, for example, quality incidents open in a forensic lab's compliance management software. Quality TAT element 354 can display the average number of network days quality incidents have been open over a period. For example, Quality TAT element 354 can display the average number of network days closed quality incidents have been open over the last 6 months. Average age of Open Reports element 356 can display the average amount of time all open quality incidents have been open. Quality Filter element 358 can be a selectable menu, such as a drop-down menu, that allows for the quality incident data displayed in Quality Reports element 350 to be filtered. Some of examples of possible filters are service type and forensic discipline as previously described herein.

Pending Request Status element 360 can display counts of pending requests in each phase of work. For example, Pending Request Status element 360 can include Unassigned element 362 that displays the number of unassigned requests, Pending Draft element 364 that displays the number of requests that have been assigned but have not yet had a report created, Pending Tech element 366 that displays the number of requests awaiting technical review by qualified personnel, and Pending Admin element 368 that displays the number of requests awaiting administrative review by qualified personnel.

Dashboard 300 can include filters that can narrow or alter the data presented in the dashboard. For example, dashboard 300 can include service filter 372 and role filter 374 shown in FIG. 3A. Service filter 372 can be, for example, a drop-down menu with a list of services. When a service is selected dashboard 300 can be altered to display only data related to the selected service. Examples of types of services have been previously described herein. Role filter 374 can filter the data displayed in dashboard 300 by user role, such as supervisor, admin, etc. The data can be filtered in any way, based on any attribute relating to the relevant data.

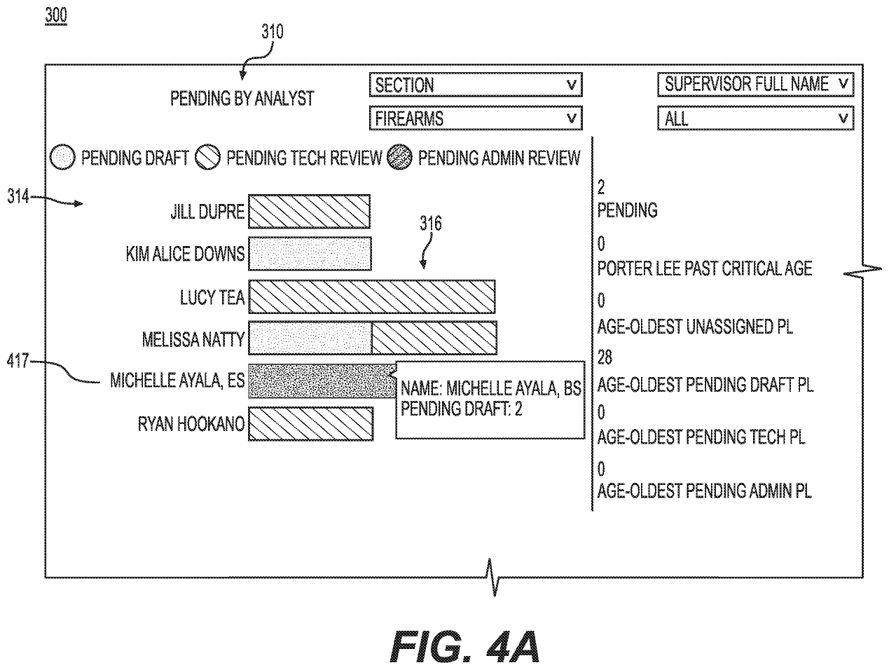

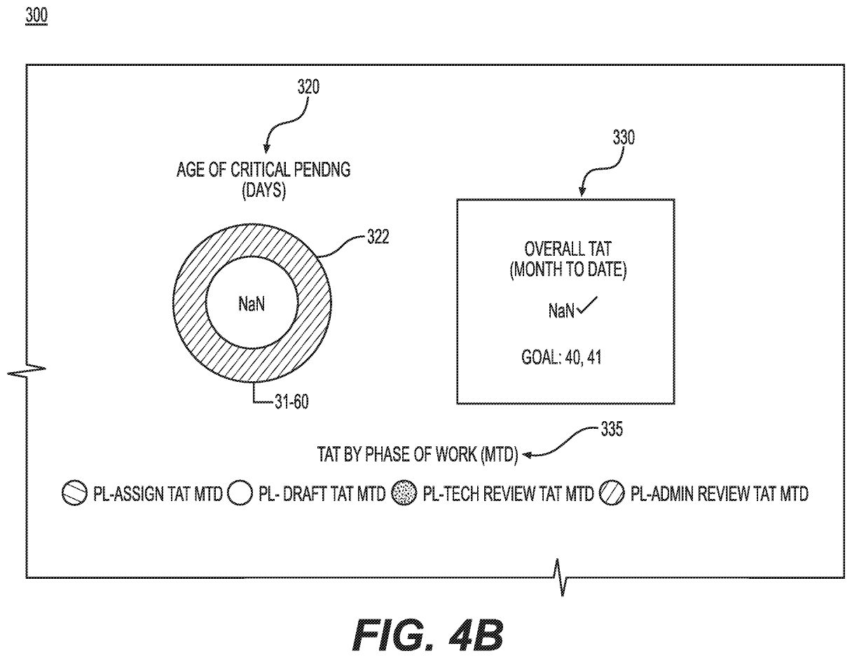

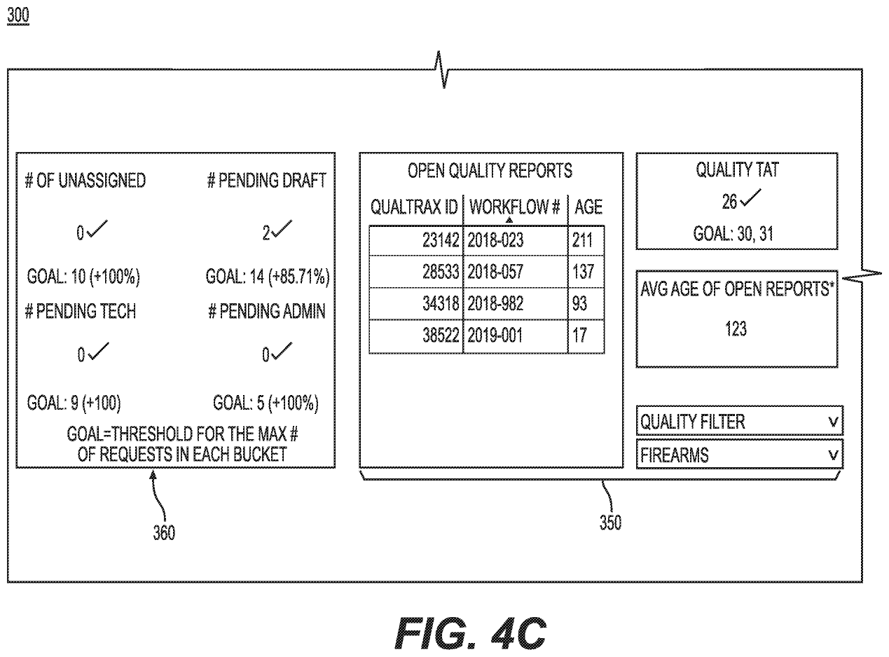

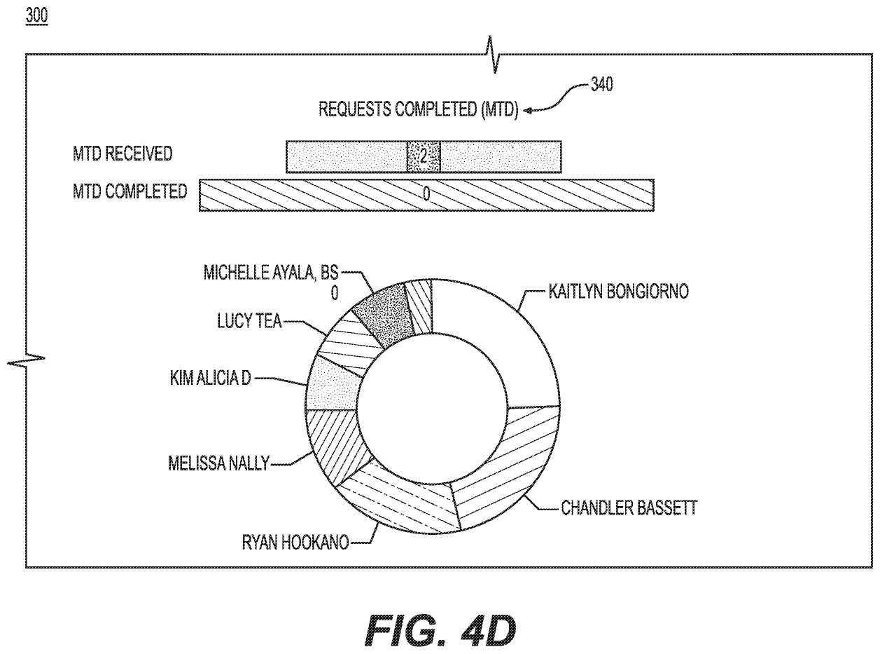

The GUI elements of dashboard 300 can be control elements that facilitate a user-computer interaction, such as a widget. The GUI elements can be interconnected such that an interaction with one element can cause a change in other elements. FIGS. 4A-4D illustrate an example of such a user-computer interaction where an analyst 417 has been selected from list of analysts 314. Graphical data corresponding to analyst 417 has been darkened and all other data becomes semi-transparent. This contrast help highlight data corresponding to analyst 317. For example, the visualization of pending requests 316 is darkened next to analyst 417 and semi-transparent for all other users in order to highlight the pending requests related to analyst 417. Graphic 322 of Age of Critical Pending element 320 is semi-transparent with the next “NaN.” In this example, this can indicate that there are no critical pending requests assigned to analyst 417. Similarly, Overall TAT element 330 is semi-transparent with the text “NaN” indicating that analyst 317 has not completed any requests yet. In a similar manner, TAT by Phase of Work element 335, Requests Received/Completed element 340, Quality Reports element 350, and Pending Request Status element 360 have all been altered to highlight data corresponding to analyst 417.

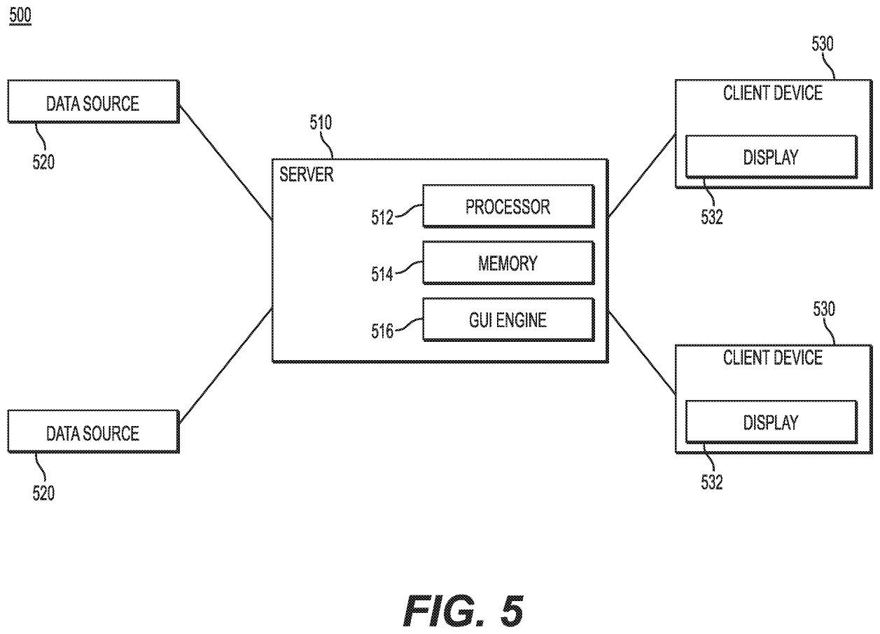

FIG. 5 includes an illustration of a system 500 for generating a GUI as described herein. System 500 can include server 510, data sources 520, and client devices 530. Server 510 can be one or more network servers that includes processor 512, memory 514, and GUI engine 516. The server 510 can be the computing device described previously and can communicate with the data sources 520 and client devices 530 using a network, such as a local area network, an enterprise network, or the Internet. Some example types of server 510 can be an application server, web server, and enterprise server. Memory 514 can be an example of a non-transitory, computer-readable storage medium. GUI engine 516 can generate a GUI dashboard, or instructions for a GUI dashboard, as previously described herein.

Server 510 can query data sources 520 to retrieve the data necessary for GUI engine 516 to generate a GUI dashboard. Once generated, server 510 can provide one or both client devices 530 with the information needed to display the GUI. In an example, server 510 can run an open-ended query to a data source 520 that causes the data source 520 to continuously transfer new information as it becomes available. This may allow GUI engine 514 to update the GUI dashboard in real time.

Data source 520 can be one or more devices from which server 510 retrieves data to generate a GUI dashboard. Some example types of data sources 520 can be an application server or database server, such as a LIMS, compliance management software database, or an RDSMS as previously described herein. Data source 520 can be local or remote. In an example, data source 520 can be part of server 510.

Client device 530 can be one or more processor-based devices, such as a personal computer, laptop, tablet, or cell phone, that includes a display 532 in which a user can interact with an interface. Client device 530 can receive the information necessary to display and run a GUI dashboard from server 510. In one example, client device 530 can include a client version of GUI engine 516, such as a graphics engine, that causes the GUI dashboard to be displayed on display 532 and relays selection input back to GUI engine 516. In another example, GUI engine 516 can create a GUI dashboard as a web application that can be accessed at the computing device 530 via a web browser. In this example, client device 530 may not need local GUI software or a GUI engine to produce the GUI dashboard.

Each client device 530 may run and display its own instance of the GUI dashboard. Accordingly, any user interactions with the GUI dashboard may only affect the GUI dashboard running on that client device 530 instead of affecting all client devices 530 running the GUI dashboard. For example, computing device 510 may receive an indication of a user interaction with the dashboard from a client device 530, such as a selection of an element. GUI engine 516 may provide updated instructions for running and displaying the GUI dashboard only to that client device 530 while instructions to all other client devices 530 with the GUI dashboard remain the same.

In another example, the GUI engine 516 provides information to a client device 530 sufficient to allow the client device 530 to access instructions for updating or changing the GUI on the display 532. For example, the GUI engine 516 can instruct the client device 530 to, if a particular analyst from a list of analysts is selected, alter the GUI by highlighting information relevant to the selected analyst, as described in FIG. 3B. This can allow the client device 530 to make certain GUI modifications without needing to contact the server 510.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

1. A system for a generating a graphical user interface (“GUI”) dashboard, comprising:
a hardware-based processor communicatively connected to a computing device; and
a non-transitory, computer-readable medium comprising instructions that, when executed by the processor, cause the processor to effectuate operations comprising:
retrieving data from a plurality of forensics data sources;
processing the data based on predetermined parameters based on a role of a user, wherein the role is selected on a GUI from multiple roles, the roles including at least a supervisor and an analyst at a forensics lab; and
displaying a forensics GUI dashboard for the user of the forensics lab, wherein the GUI dashboard comprises a plurality of GUI elements that graphically present the processed data, the forensics GUI dashboard comprising:
a list of analysists assigned to the user of the forensics lab;
proximately located to each analyst of the forensics lab, a graphical representation of a number of requests assigned to the corresponding analyst, wherein the requests are based on the plurality of forensics data sources and are visually distinguished based on draft status and review status; and
a graphical representation of the total number of requests completed within a predetermined time period by at least two of the analysts in the list.

2. The system of claim 1, wherein at least one of the plurality of GUI elements comprises a graphical representation of at least four of:
a total number of pending requests at the forensics lab;
a number of pending requests in multiple phases of work at the forensics lab, including multiple review phases;
an average age of pending requests that have been open beyond a predetermined threshold;
an average request turnaround time;
a number of requests completed over a period of time;
an average age of all pending quality incidents; and
an average number of network days closed quality incidents had been pending over a time period.

3. The system of claim 1, the instructions further comprising:
receiving an indication of a selection of a portion of one of the plurality of GUI elements; and
responsive to the selection, modifying a portion of a different GUI element corresponding to the selected portion.

4. The system of claim 3, wherein modifying the portion of the different GUI element comprises highlighting a portion of the different GUI element that is based on data related to the selected portion.

5. The system of claim 1, further comprising at least one selectable filter filtering the processed data presented in the dashboard, wherein the at least one selectable filter comprises at least one of:
a user role filter;
a forensic lab service type filter; and
a forensic discipline filter.

6. The system of claim 1, wherein processing the data comprises validating, aggregating, and analyzing the data.

7. The system of claim 1, wherein the processor retrieves data by sending an open-ended SQL query to the plurality of data sources and the data is received in as a database view.

8. A non-transitory storage medium coupled to a hardware-based processor, the memory having stored thereon instructions that when executed by the processor cause the processor to effectuate operations comprising:
retrieving data from a plurality of forensics data sources;
processing the data based on predetermined parameters based on a role of a user, wherein the role is selected on a graphical user interface (GUI) from multiple roles, the roles including at least a supervisor and an analyst at a forensics lab; and
displaying a forensics GUI dashboard for the user of the forensics lab, wherein the GUI dashboard comprises a plurality of GUI elements that graphically present the processed data, the forensics GUI dashboard comprising:
a list of analysists assigned to the user of the forensics lab;
proximately located to each analyst of the forensics lab, a graphical representation of a number of requests assigned to the corresponding analyst, wherein the requests are based on the plurality of forensics data sources and are visually distinguished based on draft status and review status; and
a graphical representation of the total number of requests completed within a predetermined time period by at least two of the analysts in the list.

9. The non-transitory storage medium of claim 8, wherein at least one of the plurality of GUI elements comprises a graphical representation of at least four of:
a total number of pending requests at the forensics lab;
a number of pending requests in multiple phases of work at the forensics lab, including multiple review phases;
an average age of pending requests that have been open beyond a predetermined threshold;
an average request turnaround time;
a number of requests completed over a period of time;
an average age of all pending quality incidents; and
an average number of network days closed quality incidents had been pending over a time period.

10. The non-transitory storage medium of claim 8, the instructions further comprising:
receiving an indication of a selection of a portion of one of the plurality of GUI elements; and
responsive to the selection, modifying a portion of a different GUI element corresponding to the selected portion.

11. The non-transitory storage medium of claim 10, wherein modifying the portion of the different GUI element comprises highlighting a portion of the different GUI element that is based on data related to the selected portion.

12. The non-transitory storage medium of claim 8, the instructions further comprising at least one selectable filter filtering the processed data presented in the dashboard, wherein the at least one selectable filter comprises at least one of:
a user role filter;
a forensic lab service type filter; and
a forensic discipline filter.

13. The non-transitory storage medium of claim 8, wherein processing the data comprises validating, aggregating, and analyzing the data.

14. The non-transitory storage medium of claim 8, wherein retrieving data comprises sending an open-ended SQL query to the plurality of data sources and the data is received as a database view.

15. A method for a generating a graphical user interface (“GUI”) dashboard, comprising:
retrieving data from a plurality of forensics data sources;
processing the data based on predetermined parameters based on a role of a user, wherein the role is selected on the GUI from multiple roles, the roles including at least a supervisor and an analyst at a forensics lab; and
displaying a forensics GUI dashboard for the user of the forensics lab, wherein the GUI dashboard comprises a plurality of GUI elements that graphically present the processed data, the forensics GUI dashboard comprising:
a list of analysists assigned to the user of the forensics lab;
proximately located to each analyst of the forensics lab, a graphical representation of a number of requests assigned to the corresponding analyst, wherein the requests are based on the plurality of forensics data sources and are visually distinguished based on draft status and review status; and
a graphical representation of the total number of requests completed within a predetermined time period by at least two of the analysts in the list.

16. The method of claim 15, wherein at least one of the plurality of GUI elements comprises a graphical representation of at least four of:
a total number of pending requests at the forensics lab;
a number of pending requests in multiple phases of work at the forensics lab, including multiple review phases;
an average age of pending requests that have been open beyond a predetermined threshold;
an average request turnaround time;
a number of requests completed over a period of time;
an average age of all pending quality incidents; and
an average number of network days closed quality incidents had been pending over a time period.

17. The method of claim 15, further comprising:
receiving an indication of a selection of a portion of one of the plurality of GUI elements; and
responsive to the selection, modifying a portion of a different GUI element corresponding to the selected portion.

18. The method of claim 17, wherein modifying the portion of the different GUI element comprises highlighting a portion of the different GUI element that is based on data related to the selected portion.

19. The method of claim 15, further comprising at least one selectable filter filtering the processed data presented in the dashboard, wherein the at least one selectable filter comprises at least one of:
a user role filter;
a forensic lab service type filter; and
a forensic discipline filter.

20. The method of claim 15, wherein processing the data comprises validating, aggregating, and analyzing the data.
